(19) United States
(12) Patent Application Publication
(10) Pub. No.: US 2005/0057184 A1
(43) Pub. Date: Mar. 17, 2005

(54) Method and apparatus for managing temperature of light emitting element, and lighting apparatus

(75) Inventors: Masaaki Kaneko, Chuo-ku (JP); Kenichi Hayami, Chuo-ku (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK CORPORATION, Tokyo (JP)

(21) Appl. No.: 10/898,244

(22) Filed: Jul. 26, 2004

(30) Foreign Application Priority Data
Aug. 25, 2003 (JP) 2003-299465

(51) Int. Cl. H05B 41/16

(52) U.S. Cl. 315/247

(57) ABSTRACT

The present invention aims at providing a lighting apparatus which is simple in configuration and which is capable of providing a stable light quantity from a light source constituted by an LED or the like. In the present invention, attention is paid to the fact that an applied voltage to an LED changes in correspondence to a temperature of the LED, and hence a temperature control device constituted by a Peltier element or the like is operated in correspondence to the quantity of change in applied voltage to the LED.

### BACKGROUND OF THE INVENTION

1. Field of the Invention

The present invention relates in general to a lighting apparatus constituted by light emitting elements such as light emitting diodes. In particular, the present invention relates to a method and apparatus for managing temperatures of light emitting elements used in a lighting apparatus which is capable of providing a stable light quantity and which has a long life.

2. Related Background Art

For example, there is known an inspection apparatus for photographing an object of inspection using a camera to carry out the quality control of the object based on the photography results. In such an inspection apparatus, in order to make an image of the object clearer, a lighting apparatus for lighting up an object is also simultaneously used. As for this lighting apparatus, there is used one having a plurality of light emitting diodes (hereinafter referred to as “LEDs” for short when applicable) used therein because the light emitting diode has essentially the high directivity and hence does not require a reflecting plate or the like, and is miniature and has a low power consumption, and so forth.

However, the LED has the characteristics that a temperature thereof changes in correspondence to the use situation, and the light quantity thereof also changes in correspondence to the change in temperature. More specifically, the LED has the characteristics that when the temperature thereof rises, the light quantity thereof decreases, and, for example, after the light quantity becomes temporarily stable after the LED has been turned ON, the temperature rises with a lapse of the lighting time to decrease the light quantity. For this reason, in the usual way, those LEDs are used while their temperatures are controlled by a temperature measurement device and a cooling device such as a Peltier element which are disposed in the vicinities of the LEDs.

Examples of a related art example in which the LEDs are used in the lighting apparatus, and the temperatures of the LEDs are managed include ones disclosed in Japanese Patent Application Laid-Open No. 2002-101274, Japanese Patent Application Laid-Open No. 2001-043728, and Japanese Patent Application Laid-Open No. 2000-337967.

Usually used as the above-mentioned temperature measurement device is a thermistor described in Japanese Patent Application Laid-Open No. 2002-101274, a thermoelectric couple described in Japanese Patent Application Laid-Open No. 2001-043728, or the like. Such a temperature measurement device is fixed in a state of thermally conducting with a member having the LEDs fixed thereto through a member having a high coefficient of thermal conductivity. Consequently, in fact, such a temperature measurement device does not directly measure temperatures of the LEDs. In addition, those temperature measurement devices individually require wirings. Thus, in the lighting apparatus having a plurality of LEDs installed therein, it may not be practical to measure the temperatures of the individual LEDs.

That is to say, with the conventional constitution, it has been difficult to directly grasp the temperature states of the LEDs. In addition, there is a possibility that errors occurring between the actual temperatures of the LEDs and the measured temperatures may change depending on the disposition or the like of the temperature measurement devices. Moreover, for example, in case of a lighting apparatus having a plurality of LEDs, even if the temperature of an LED located apart from a temperature measurement point changes, and hence the light quantity of the LED changes, it has been difficult to detect the change in light quantity of the LED concerned.

When a lighting state of an object for the lighting apparatus is changed owing to these factors, the quantity of change in lighting state has not become a problem in the normal photographing conditions up to this day, or the photographing or the like has been carried out under the conditions in which the quantity of change does not become a problem. However, for example, in the case where the mounting state of an electronic component is inspected, when the electronic component, the mounting board, and the like are miniaturized, and also the color tones or the like in their materials become close to each other, it may become unable to disregard the change in the above-mentioned lighting state. In addition, when the camera and the lighting apparatus are miniaturized, it is also supposed that the disposition itself of the temperature measurement device within the lighting apparatus becomes difficult to be carried out.

### SUMMARY OF THE INVENTION

The present invention has been made in the light of the above circumstances, and it is, therefore, an object of the present invention to provide a method and an apparatus for managing a temperature of a light emitting element which are capable of grasping individual temperature situations of light emitting diodes or the like in a lighting apparatus or the like to make control for the individual temperature situations of light emitting diodes or the like possible. It is another object of the present invention to provide a lighting apparatus which is capable of lighting up an object while maintaining a more stable light quantity using the above-mentioned temperature management apparatus.

In order to solve the above-mentioned problems, according to the present invention, there is provided a method of managing a temperature of a light emitting element in a lighting apparatus having the light emitting element and a temperature control device disposed in the vicinity of the light emitting element, the method including: detecting a voltage or current of any one of the light emitting element and the temperature control device in correspondence to a change in temperature of the light emitting element in a light emitting state; and controlling the temperature control device based on the detection results.

In order to solve the above-mentioned problems, according to the present invention, there is provided an apparatus for managing a temperature of a light emitting element in a lighting apparatus having the light emitting element and a temperature control device disposed in the vicinity of the light emitting element, the apparatus including: a measurement system for detecting a voltage or current of any one of the light emitting element and the temperature control device, in which temperature control device is controlled based on the voltage or current measured by the measurement system.

In order to solve the above-mentioned problems, according to the present invention, there is provided a lighting apparatus including a light emitting diode and a temperature control device disposed in the vicinity of the light emitting diode, the lighting apparatus further including a power source for supplying a constant current to the light emitting diode, and a voltage measurement device for measuring a voltage applied to the light emitting diode, in which temperature control is carried out by the temperature control device based on the measurements obtained from the voltage measurement device. Normally, when the temperature of the light emitting diode changes, the voltage applied to the light emitting diode is changed along with the change in temperature of the light emitting diode concerned. Thus, the light emitting diode has a fixed relationship in the quantities of individual changes. In the present invention, attention is paid to this relationship, and thus a change in applied voltage to the light emitting diode is measured, and the cooling or the like of the light emitting diode is carried out by the temperature control device based on the measurements.

In order to solve the above-mentioned problems, according to the present invention, there is provided a lighting apparatus including a light emitting diode and a Peltier element disposed in the vicinity of the light emitting diode, the lighting apparatus further including a power source for supplying a constant current to the light emitting diode, and a current measurement device for measuring a value of a current generated by the Peltier element, in which a value of a current supplied to the Peltier element is controlled based on the measurements obtained from the current measurement device. It is known that a Peltier element has a cooling surface and a heat radiating surface, and also has the so-called Seebeck effect of, when a temperature relationship between the cooling surface and the heat radiating surface changes, generating a current based on the quantity of change in temperature relationship. A value of the current based on the Seebeck effect is measured, and an operation of the Peltier element is controlled based on the measurements, whereby the Peltier element and an object cooled by the Peltier element can be held at predetermined temperatures, respectively.

In order to solve the above-mentioned problems, according to the present invention, there is provided a lighting apparatus including a light emitting diode and a temperature control device disposed in the vicinity of the light emitting diode, the lighting apparatus further including: a power source for supplying a constant current to the light emitting diode; and a measurement apparatus for measuring a value of at least one of a voltage applied to the light emitting diode and a current supplied to the temperature control device, in which temperature control device is controlled based on the value of the voltage or the current.

In order to solve the above-mentioned problems, according to the present invention, there is provided a lighting apparatus including a light source and a temperature control device disposed in the vicinity of the light source, the lighting apparatus further including: a power source for the light source; a power source for the temperature control device; and a measurement system for detecting a quantity of change in voltage or current of at least one of the light source and the temperature control device, the voltage or current changing in correspondence to a change in temperature of the light source, in which an output from the power source for the temperature control device is controlled based on the detection results obtained from the measurement system.

In a temperature management apparatus according to a first or second aspect of the present invention, in at least one of a light emitting diode constituting a light emitting element, and a Peltier element constituting a temperature control device, either a voltage or a current generated in correspondence to a change in temperature while the light emitting diode emits light is detected without using a temperature measurement device or the like, and the Peltier element is operated based on the detection results. Consequently, the various problems which may arise owing to the presence of a thermometer or the like in the prior art can be substantially all prevented from arising.

In a lighting apparatus according to a third aspect of the present invention, the temperature of a light emitting diode is directly and suspectedly obtained based on the change in voltage applied to the light emitting diode without using a temperature measurement device or the like. Consequently, the various problems which may arise owing to the presence of a thermometer or the like in the prior art can be substantially all prevented from arising. In addition, even when a plurality of light emitting diodes are used, it is possible to simplify a circuit configuration of the lighting apparatus, and it is possible to adjust the luminance of the individual light emitting diodes with high accuracy. Consequently, according to the present invention, it is possible to obtain a lighting apparatus which is capable of usually providing a stable lighting state.

In addition, in a lighting apparatus according to a fourth aspect of the present invention, a current generated owing to the change in temperature of a Peltier element constituting a temperature control device is measured as a substitute for the change in temperature of the light emitting diode, and the feedback is applied to the Peltier element based on the measurements. Consequently, as compared with the conventional constitution requiring a thermometer or the like as an essential constituent element, it is possible to obtain the same effects as those of the above-mentioned first aspect of the present invention. However, the fourth aspect of the present invention is inferior to the above-mentioned first aspect of the present invention in that the light quantity is held constant in terms of the lighting apparatus since the state of the light emitting diode is not directly detected. However, when the heat capacity of the temperature control device including a Peltier element and a heat radiating plate having the Peltier element fixed thereto is large, it is possible to obtain an effect that the temperature of the temperature control device itself can be more stably held.

It should be noted that the lighting apparatuses according to the above-mentioned third and fourth aspects of the present invention can also be used in a state of being juxtaposed with a single lighting apparatus. The present invention can be implemented only by adding a wiring to an output terminal of a power source to which the light emitting diode or the Peltier element constituting the temperature control device is connected so as to be able to detect a change in output of the power source for the light emitting diode or the Peltier element. Thus, in this case, a change-over switch, and a voltage or current measurement apparatus may be disposed in the vicinity of the power source. Consequently, it is easy to dispose both the change-over switch and the voltage or current measurement apparatus, and hence adoption of this constitution allows the light emitting state of the light emitting diode to be further stabilized.

### BRIEF DESCRIPTION OF THE DRAWINGS

FIG. 1 is a block diagram showing a circuit configuration of a lighting apparatus according to one aspect of the present invention;

FIG. 2 is a circuit diagram showing a main portion in the block diagram of the lighting apparatus shown in FIG. 1;

FIG. 3 is a block diagram showing a circuit configuration of a lighting apparatus according to another aspect of the present invention;

FIG. 4 is a circuit diagram showing a main portion in the block diagram of the lighting apparatus shown in FIG. 3;

FIG. 5 is a perspective view showing a schematic construction of a camera to which a lighting apparatus according to an embodiment of the present invention is mounted; and

FIG. 6 is a cross sectional view showing a schematic cross section of the construction shown in FIG. 5.

### DESCRIPTION OF THE PREFERRED EMBODIMENTS

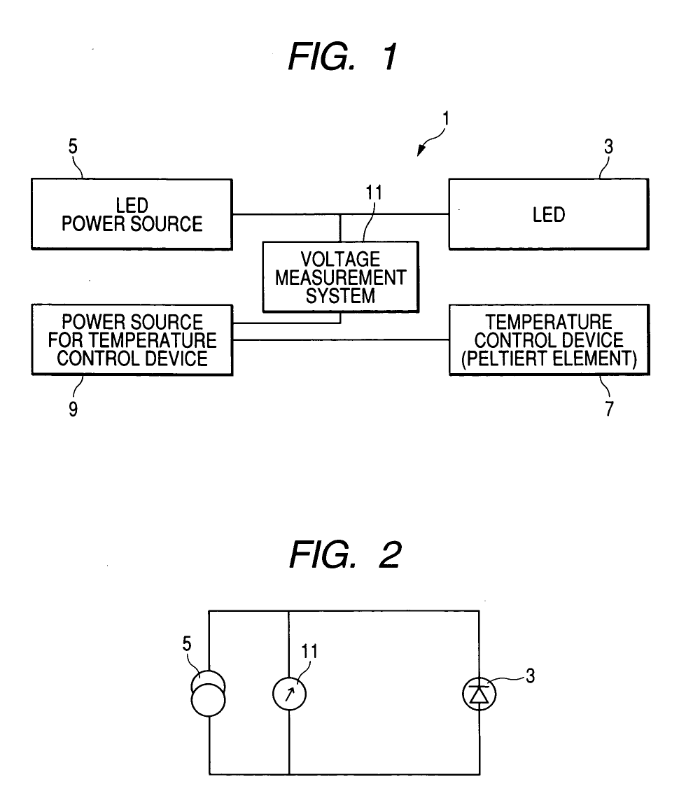

Aspects of the present invention will hereinafter be described in detail with reference to the accompanying drawings. FIG. 1 is a block diagram showing a schematic configuration of a lighting apparatus according to one aspect of the present invention. In addition, FIG. 2 shows actual disposition of a measurement system for measuring a voltage or the like. A lighting apparatus 1 according to this aspect of the present invention includes a light emitting diode (LED) 3, a power source 5 for the LED 3, a temperature control device (including a Peltier element) 7, a power source 9 for the temperature control device 7, and a voltage measurement system 11. In actual, as shown in FIG. 2, the voltage measurement system 11 is disposed so as to measure a voltage applied to the LED 3.

As described above, a voltage required to cause a constant current to flow through the LED 3 changes along with a change in temperature of the LED 3. The quantity of change in temperature of the LED 3 is measured by the voltage measurement system 11 disposed as shown in FIG. 2 to thereby make it possible to know the temperature of the LED 3. Note that in this aspect, the voltage directly applied to the Peltier element 7 is controlled based on the resultant change in voltage. However, it may also be adopted that a temperature is obtained from the resultant change in voltage once, and the Peltier element 7 is operated based on the resultant temperature.

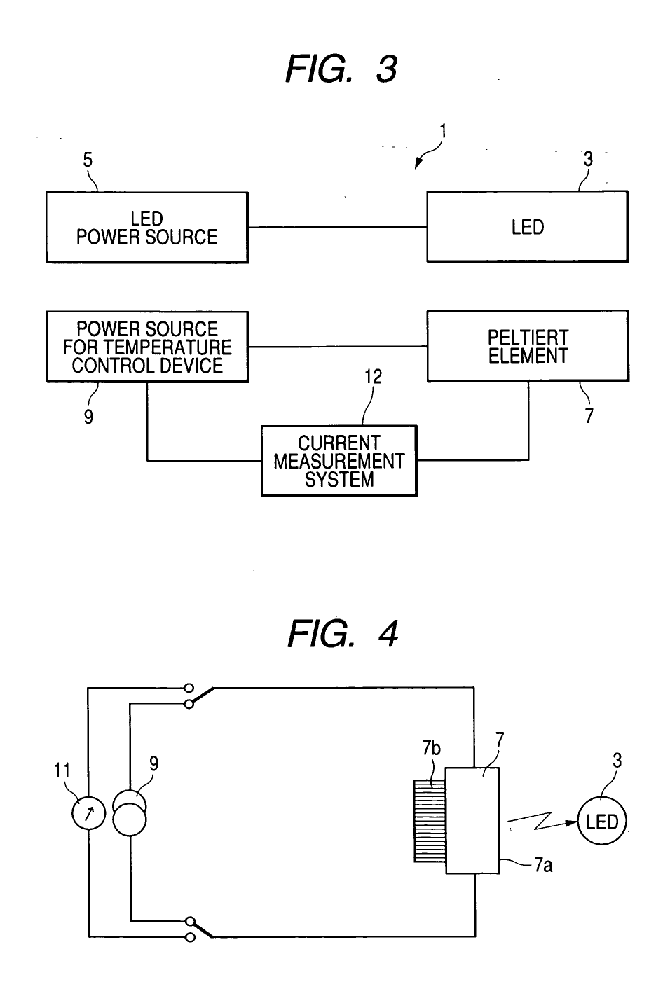

FIG. 3 is a block diagram showing a schematic configuration of alighting apparatus according to another aspect of the present invention. In addition, FIG. 4 shows actual disposition of a measurement system for measuring a voltage or the like. A lighting apparatus 1 according to the present invention includes a light emitting diode (LED) 3, a power source 5 for the LED 3, a temperature control device (including a Peltier element) 7, a power source 9 for the temperature control device 7, and a current measurement system 12. In actual, as shown in FIG. 4, the current measurement system 12 is disposed so as to measure a voltage applied to the Peltier element 7.

The Peltier element 7 is disposed so as to nearly contact the LED 3. Then, a cooling surface 7a of the Peltier element 7 faces an LED 3 side, and a heat sink 7b and the like of the Peltier element 7 are disposed on a side opposite to the LED 3 side. It is known that the Peltier element 7 generates a current in correspondence to a difference in temperature between the both surfaces. This current is measured by the current measurement system 12, whereby it becomes possible to know changes in temperature of the Peltier element 7 and the LED 3 nearly contacting the Peltier element 7. The Peltier element 7 is charged with electricity so as to cancel the changes in temperature to thereby allow the temperatures of the LED 3 and the like to be stabilized.

Adoption of the constitution of the above-mentioned aspects of the present invention makes it possible to use the LED in the lighting apparatus in a more stable temperature state. In addition, according to another aspect of the present invention described above, a thermometer or the like is unnecessary in terms of a configuration. Therefore, it becomes possible to remove the unstable factors such as an error of a measurement position, and imperfect connection of a thermometer due to adoption of the thermometer and the like. Thus, it becomes possible to provide a more stable lighting system. While the description has not been given with respect to the number of LEDs in FIGS. 1 to 4, the number of LEDs, the number of power sources for the LEDs, and the like should be suitably changed in correspondence to a use thereof. Hence, the system for measuring a voltage and a current may be determined in number whenever necessary in correspondence to the requisite stability of the temperature.

### PREFERRED EMBODIMENT

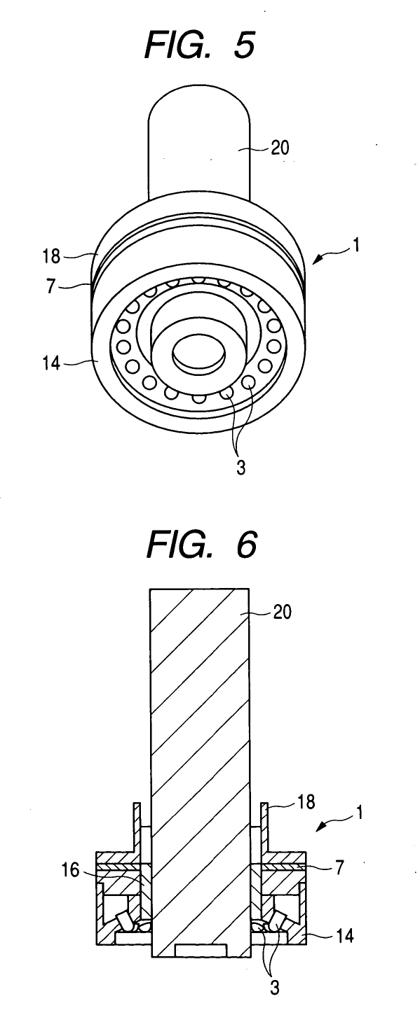

Next, a preferred embodiment using the lighting apparatus according to the present invention will hereinafter be described with reference to FIGS. 5 and 6. FIG. 5 shows a schematic perspective view in a state in which the lighting apparatus according to the present invention is constructed in the form of a unit to be mounted to a camera. FIG. 6 shows a schematic cross section of the construction shown in FIG. 5. The lighting apparatus 1 has a nearly ring like shape, and a camera 20 is inserted into a through hole portion of the lighting apparatus 1. In addition, the lighting apparatus 1 has a ring like LED case 14 to which a plurality of LEDs 3 are fixed so as to be directed downwardly, and a ring like Peltier element 7 stuck to a rear surface of the LED case 14.

A cylindrical thermal transfer member 16 which is also tightly stuck to the Peltier element 7 is tightly fixed to an inner peripheral portion of the through hole of the LED case 14. The camera 20 is provided so as to extend completely through the through hole in a state of being tightly stuck to the thermal transfer member 16, and is held at the same temperature as that of the LED case 14 through the thermal transfer member 16. In addition, a heat radiating plate (corresponding to the heat sink 7b in FIG. 4) 18 is mounted to a surface of the Peltier element 7 opposite to the sticking surface with the LED case 14 to thereby enhance the cooling efficiency of the Peltier element 7. The LEDs 3 and the Peltier element 7 are connected to respective power sources (not shown) and respective measurement systems (not shown). Thus, the temperature of the LEDs 3 is held constant in accordance with the above-mentioned method and apparatus of the present invention.

The adoption of the lighting apparatus 1 having the above-mentioned constitution allows a subject of the camera 20 to be usually lighted up with a stable light quantity. Thus, it becomes possible to stably obtain a clear image of the subject. In addition, the power sources of the LEDs 3 and the Peltier element 7, and the construction required to control the LEDs 3 and the Peltier element 7 can be all constructed separately from the lighting apparatus 1. As a result, it becomes possible to provide the miniature and simple lighting apparatus which can be readily fixed to the camera 20, and which can provide a stable light quantity.

The lighting apparatus which is used for such a construction that an article lighted up with a stable light quantity is inspected using the camera has been exemplified as the embodiment of the present invention. However, the implementation of the present invention is not intended to be limited to this field, and hence the present invention can be applied to various optical apparatuses each adapted to utilize the directivity and the like of an LED. In addition, the idea of the present invention is not applied to only an LED, but can also be applied to a light source in which the light quantity which can be provided by the light source is not stabilized unless a use temperature of the light source is stabilized. More specifically, there may be adopted a constitution that a temperature is not directly obtained from a light source which can provide a stable light quantity by being cooled or heated, but a use situation of the light source is obtained from a voltage or the like of the light source, or a voltage or the like of a temperature control device to be fed back. With this constitution, the temperature of the light source may be controlled.

1. A method of managing a temperature of a light emitting element in a lighting apparatus having the light emitting element and a temperature control device disposed in a vicinity of the light emitting element, the method comprising:
detecting a change in voltage or current of any one of the light emitting element and the temperature control device in correspondence to a change in temperature of the light emitting element in a light emitting state; and
controlling the temperature control device based on the detection results.

2. An apparatus for managing a temperature of a light emitting element in a lighting apparatus having the light emitting element and a temperature control device disposed in a vicinity of the light emitting element, the apparatus comprising:
a measurement system for detecting a value of a voltage or current of any one of the light emitting element and the temperature control device,
wherein the temperature control device is controlled based on the value of the voltage or current measured by the measurement system.

3. A lighting apparatus comprising a light emitting diode and a temperature control device disposed in a vicinity of the light emitting diode, the lighting apparatus further comprising:
a power source for supplying a constant current to the light emitting diode; and
a voltage measurement device for measuring a voltage applied to the light emitting diode,
wherein temperature control is carried out by the temperature control device based on the measurements obtained from the voltage measurement device.

4. A lighting apparatus comprising a light emitting diode and a Peltier element disposed in a vicinity of the light emitting diode, the lighting apparatus further comprising:
a power source for supplying a constant current to the light emitting diode; and
a current measurement device for measuring a value of a current generated by the Peltier element,
wherein a value of a current supplied to the Peltier element is controlled based on the measurements obtained from the current measurement device.

5. A lighting apparatus comprising a light emitting diode and a temperature control device disposed in a vicinity of the light emitting diode, the lighting apparatus further comprising:
a power source for supplying a constant current to the light emitting diode; and
a measurement apparatus for measuring a value of at least one of a voltage applied to the light emitting diode and a current supplied to the temperature control device,
wherein temperature control device is controlled based on the value of one of the voltage and the current.

6. A lighting apparatus comprising a light source and a temperature control device disposed in a vicinity of the light source, the lighting apparatus further comprising:
a power source for the light source;
a power source for the temperature control device; and
a measurement system for detecting a quantity of change in voltage or current of at least one of the light source and the temperature control device, the voltage or current changing in correspondence to a change in temperature of the light source,
wherein an output from the power source for the temperature control device is controlled based on the detection results obtained from the measurement system.
